(19) United States
(12) Patent Application Publication
(10) Pub. No.: US 2007/0131898 A1
(43) Pub. Date: Jun. 14, 2007

(54) Antifreeze composition

(76) Inventors: Sung Choon Yoo, Gwacheon-si (KR); Young Joo Ha, Busan (KR); Chang Yul Cho, Busan (KR); Dong Ryeol Choi, Busan (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/498,615

(22) Filed: Aug. 3, 2006

(30) Foreign Application Priority Data
Dec. 12, 2005 (KR) 10-2005-0121759

(51) Int. Cl. C09K 5/00

(52) U.S. Cl. 252/73

(57) ABSTRACT

The present invention relates to an improved antifreeze composition for use in engine cooling systems. The composition of the invention has sustained corrosion inhibiting properties even at relatively low concentrations and when used with hard water. The composition comprises an antifreeze agent, an organic acid, a poly(organic acid), dimercapto thiadiazole, a hard water stabilizer, a phosphate salt, a triazole or thiazole and alkali metal hydroxide.

### CROSS REFERENCE TO RELATED APPLICATION

This application is based on, and claims priority to Korean Patent Application No. 2005-0121759, filed on Dec. 12, 2005, the disclosure of which is incorporated herein by reference in its entirety.

### FIELD OF THE INVENTION

The present invention relates generally to an antifreeze composition. More specifically, the present invention relates to improved antifreeze compositions having sustained anti-corrosion properties that can be used in engine cooling systems.

### BACKGROUND OF THE INVENTION

Antifreeze functions by picking up heat as it circulates through the engine and releasing this heat as the antifreeze passes through the radiator. Generally, antifreeze compositions are formulated using alkylene glycols as an antifreeze agent(s), e.g. ethylene glycol, propylene glycol, or derivatives thereof. When used in vehicle or aircraft cooling systems, antifreeze agents are diluted with water to ensure good heat dissipation as well as to provide protection against freezing. In addition to antifreeze agents, most compositions also include additives such as corrosion inhibitors, anti-foaming agents, and dyes.

As those of ordinary skill in the art would recognize, alkylene glycol/water mixtures are very corrosive at the typical operating temperatures of combustion engines. For this reason, the various metals, e.g. as steel, cast iron, copper, brass, aluminum, magnesium and alloys thereof, as well as solder metals, e.g. solder tin, which are used in cooling systems have to be adequately protected against a wide variety of types of corrosion, e.g. pitting corrosion, crevice corrosion, erosion or cavitation, through the use of corrosion inhibitors.

The corrosion inhibitors have the important function of inhibiting and reducing scale formation and corrosion of metals in the engine and coolant systems. Inhibitors well-known in the art include silicates, phosphates, borates, nitrites, and amine additives. Many of these conventional inhibitors are abrasive to water pump seals and each aforementioned inhibitor has problems attendant upon use.

For example, while silicates are good for protecting aluminum against corrosion, they are chemically unstable and tend to gel in response to changes in temperature and/or pH and/or presence of other salts. As a result, silicate corrosion inhibitors are depleted quite rapidly, thereby severely limiting the overall life-span of the antifreeze composition. Another class of corrosion inhibitors, borates, was originally designed for engines constructed almost entirely from cast iron. With the advent of high performance engines however, light-weight metal alloys, many of which include aluminum, became increasingly used in engine components and borates' corrosive effect on aluminum and cast aluminum under heat transfer conditions became known.

Phosphates, another conventional corrosion inhibitor, have a propensity to precipitate in hard water and thereby obstruct antifreeze circulation. Amine salts, once used in antifreeze, are now prohibited from use since they were discovered to produce nitrosamine, a toxic chemical, upon reaction with nitrite in antifreeze composition.

Compounding the above problems is the fact that many of the intended benefits of additives in antifreeze compositions can be thwarted by the presence of hard water in the cooling system. Antifreeze concentrates are typically diluted with water to form the working antifreeze compositions during initial fill-up or subsequent top-off. The level of impurities in the water with which the antifreeze concentrate is diluted typically has tremendous effects on the performance of the antifreeze. Hard water includes a number of minerals, e.g. calcium, magnesium and iron salts, which can impair the effective lifespan of the antifreeze composition. An ineffective antifreeze composition can shorten engine life, allow internal passageways in the cooling system to clog, contribute to cylinder liner pitting and water pump cavitation, all of which result in costly engine overhauls or repairs.

The lifespan of most commercially available antifreeze compositions is about two to three years due to depletion of antifreeze corrosion inhibitors. Once the corrosion inhibitors are used up, the antifreeze becomes corrosive and starts to corrode metal parts inside the engine and cooling system. As such, efforts are being aimed at developing new additives for antifreeze compositions that can increase their lifespan and be suitable for use with hard water.

Several organic acids-based antifreeze compositions have been developed in the art to have sustained corrosion inhibiting properties. See U.S. Pat. No. 6,096,236, U.S. Pat. No. 5,961,875, Japanese Pat. Hei 10-67982, U.S. Pat. No. 5,723,061, European Pat. 0564721, and U.S. Pat. No. 5,741,436. These compositions however suffer from certain drawbacks. The corrosion inhibitors used therein tend to be low in solubility and must undergo heat treatment to be made soluble in antifreeze compositions. Low solubility of the inhibitors presents an even greater challenge since the inhibition of solder corrosion under high temperature conditions demand high amounts of carboxylic-acid based additives and such inhibitors perform poorly at low concentrations or when used with water having corrosive anions or hard water components. As such, there is a need in the art for an improved antifreeze composition with sustained corrosion inhibiting properties.

### SUMMARY OF THE INVENTION

The present invention relates to an improved antifreeze composition for use in engine cooling systems. The composition of the invention has sustained corrosion inhibiting properties even at relatively low concentrations and when used with hard water. The composition comprises an antifreeze agent, an organic acid, a poly(organic acid), dimercapto thiadiazole, a hard water stabilizer, a phosphate salt, a triazole or thiazole and alkali metal hydroxide.

### DETAILED DESCRIPTION OF PREFERRED EMBODIMENTS

The present invention relates to an antifreeze composition comprising:
(a) about 85-98% by weight of a liquid glycol-based antifreeze agent;
(b) about 0.1-6% by weight of an alkali metal salt or an ammonium salt of C₄-C₁₆ carboxylic acid;
(c) about 0.001-0.5% by weight of dimercapto thiadiazole;
(d) about 0.1-5% by weight of a compound having formula 1;
(e) about 0.01-5% by weight of a hard water stabilizer having formula 2;
(f) about 0.1-0.5% by weight of phosphoric acid or salt thereof;
(g) about 0.01-2% by weight of triazole or thiazole;
(h) about 0.1-4% by weight of alkali metal hydroxide; and
(i) about 1-3% by weight of deionized water, 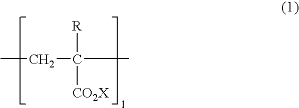
   wherein l is an integer from 10-100; R is a member selected from —H, —CH₃, —CO₂H, and —SO₃H; X is a member selected from —H, —CH₂CH₂OH, —CH₂CH₂CO₂H; and —CH₂OCH₂CH(OH)CH₂SO₃H, and 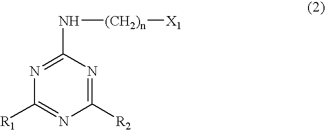
   wherein X₁ is a member selected from —OH, —COOH, —CH₃, and —CH═CH(CH₂)ₙ—CH₃; R₁ and R₂ are members independently selected from a straight or branched C₁-C₁₂ alkyl group, —(CH₂)m-X2, and —NH—(CH₂)m-X₂; n is an integer from 1-16; m is an integer from 1-16; X₂ is a member selected from —OH, —COOH, —CH3, and —CH═CH(CH₂)ₙ—CH₃.

The present invention relates to an improved antifreeze composition for use in engine cooling systems. The aforementioned components of the invention in predetermined ratios combine to produce a synergistic effect, thereby resulting in an antifreeze composition with excellent sustained corrosion inhibiting properties even at relatively low concentrations and when used with hard water.

The liquid glycol-based antifreeze agent of the present invention can be any alkylene- or poly-alkylene glycol known in the art. In preferred embodiments of the invention, the liquid glycol-based antifreeze agent is a member selected from the group consisting of ethylene glycol, dimethylene glycol, propylene glycol, dipropylene glycol, and mixtures thereof and the agent makes up about 85-98% by weight of the total antifreeze composition. Use of less than about 85% by weight of the alkylene- or poly-alkylene glycol glycol would result in an antifreeze composition with a higher freezing point and a lower boiling point. On the other hand, using an excess of 98% by weight of alkylene- or poly-alkylene glycol would severely limit the proportion of corrosion inhibiting additives that can be added, thereby reducing the overall level of metal protection offered by the resulting antifreeze composition.

The alkali metal salt or ammonium salt of C₄- C₁₆ carboxylic acid of the present invention offers effective protection of certain metals, e.g. aluminum and iron, against corrosion. It occupies about 0.1-5% by weight of the antifreeze composition. If the proportion of this compound is below about 0.1% by weight, it would offer insufficient protection against corrosion over a large surface area. In contrast, an excess of about 5% by weight of the compound would lead to decreased solubility, lowered stability, and reduced cost-effectiveness of the resulting antifreeze solution.

Any alkali metal salt or ammonium salt of C₄-C₁₆ carboxylic acid can be used for the purpose of the present invention. In preferred embodiments, the C₄-C₁₆ carboxylic acid is a C₄-C₁₂ aliphatic or aromatic organic acid selected from the group consisting of succinic acid, glutaric acid, adipic acid, pimelic acid, suberic acid, azelaic acid, sebacic acid, dicyclopentadiene dicarboxylic acid, phthalic acid, terephthalic acid, pentanoic acid, hexanoic acid, heptanoic acid, octanoic acid, 2-ethylhexanoic acid, nonanoic acid, decanoic acid, undecanoic acid, dodecanoic acid, benzoic acid, methylbenzoic acid, butylbenzoic acid, and mixtures thereof.

The dimercapto thiadiazole used in the present invention serves the role of preventing corrosion of metals such as aluminum and copper, and is used in the range of about 0.001-5% by weight. Using less than about 0.001% by weight of dimercapto thiadiazole would be insufficient to protect certain metals such as aluminums and coppers against corrosion. However, using an excess of about 5% by weight of dimercapto thiadiazole will corrode certain metals such as iron, and lead to discoloration of various metals, decreased stability and deterioration in the corrosion inhibiting properties of the antifreeze composition.

The compound having formula 1 serves to prevent corrosion of metals such as aluminum and copper, and is used in the range of about 0.1-6% by weight, preferably in the range of 0.1-3% by weight. If less than 0.1% by weight is used, it cannot provide sufficient protection against corrosion. In contrast, if more than about 6% by weight is used, the level of protection of aluminum and copper corrosion would diminish along with the compound's solubility in the antifreeze composition. Solders and coppers may also be damaged by exposure to a composition having such a excessive proportion of said compound. 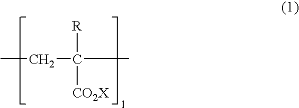
wherein l is an integer from 10-100; R is a member selected from —H, —CH₃, —CO₂H, and —SO₃H; X is a member selected from —H, —CH₂CH₂OH, —CH₂CH₂CO₂H; and —CH₂OCH₂CH(OH)CH₂SO₃H.

Exemplary hard water stabilizers useful in the present invention are provided in formula 2. The hard water stabilizer serves to prevent scale formation from exposure to minerals present in hard water, e.g. phosphate salt, or silica ions. Additionally, the hard water stabilizer can protect iron against corrosion. The compound of formula 2 is used in the range of about 0.01-0.5% weight of the antifreeze composition. If too little is used, i.e. less than about 0.01% by weight, it would be insufficient to prevent scale formation due to the lack of dispersion of minerals in hard water used with the antifreeze composition. Furthermore, the corrosion inhibiting property of the antifreeze composition as it pertains to iron will be diminished. In contrast, if too great an amount is used, i.e. more than about 0.5% weight, the cohesive function is greater than the dispersive function, thus lowering the dispersion of hard water minerals and the composition's ability to prevent scale formation. Other side effects of using an excessive amount of the hard water stabilizer include gelling of the antifreeze composition and discoloration of metal components. 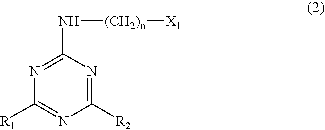
wherein X1 is a member selected from —OH, —COOH, —CH₃, and —CH═CH(CH₂)n-CH₃; R₁ and R₂ are members independently selected from a straight or branched C1-C12 alkyl group, —(CH₂)m-X₂, and —NH—(CH₂)m-X₂; n is an integer from 1-16; m is an integer from 1-16; X₂ is a member selected from —OH, —COOH, —CH₃, and —CH═CH(CH₂)n-CH₃.

The phosphoric acid or salt thereof used in the present invention serves to prevent corrosion of iron and aluminum. Any phosphoric acid or salt thereof known in the art can be used for the purpose of the present invention. In preferred embodiments, the phosphoric acid or salt thereof is a member selected from the group consisting of orthophosphoric acid, alkali metal phosphate salt and the like, and mixtures thereof since these chemicals have excellent solubility and ionic activity. The phosphoric acid or salt thereof should be used in the range of about 0.1-0.5% by weight of the antifreeze composition. Less than about 0.1% by weight of phosphoric acid or salt thereof would not achieve a sufficient level of synergistic anti-corrosive effect with the alkali metal salt or ammonium salt of C₄-C₁₆ carboxylic acid of the present invention and would fail to adequately protect certain metals such as aluminums and irons against corrosion.

In contrast, if more than 0.5% by weight is used, it will react with the minerals present in hard water, e.g. Ca⁺⁺ and Mg⁺⁺, thereby negatively affecting the corrosion inhibiting properties of the antifreeze composition and forming precipitates of calcium phosphate and magnesium phosphate which damage the mechanical seal and cause leakage of antifreeze composition. In addition, the overall balance of the antifreeze composition is destroyed with respect to attaining good corrosion-inhibiting properties as well as avoiding rapid depletion of the antifreeze composition.

The triazole or thiazole used in the present invention is a corrosion inhibitor which is particularly effective in protecting copper-based metals. These chemicals can further enhance the ability of the antifreeze to protect aluminum and iron by preventing elution of copper ions from alloys.

Any triazole or thiazole known in the art can be used for the purpose of the present invention. In preferred embodiments, triazole is a member selected from tolytriazole, benzotriazole, and mixtures thereof. In other preferred embodiments, thiazole is selected to be mercapto benzothiadiazole. The amount of triazole or thiazole to be used as additives in the present invention is in the range of about 0.01-2% by weight. If less than about 0.01% by weight is used, it will lower the corrosion inhibiting properties of the antifreeze composition on copper-based materials, thus affecting corrosion of iron- or aluminum-based metals. In contrast, using an excess of about 2% by weight will lower the cost effectiveness of the antifreeze composition and hasten corrosion of iron and solder parts.

In the present invention, alkali metal hydroxide is used as a buffer to adjust the pH of the antifreeze solution to within the range of about pH 7-9. A variety of buffers is known in the art and can be utilized for the purpose of the present invention. Exemplary buffers include sodium hydroxide, potassium hydroxide or mixtures thereof, which have excellent solubility and stability in solution.

The buffer comprises about 0.1-4% by weight of the antifreeze composition. Using less than about 0.1% by weight of buffer would have inadequate buffering capacity. In contrast, using more than about 4% by weight of buffer will lower the solubility of other additives and result in a less stable antifreeze composition.

The deionized water used in the present invention serves to dissolve those components in the antifreeze composition that are water-soluble. The deionized water should make up about 0.1-5% by weight of the antifreeze composition. If less than about 0.1% by weight is used, solubility will decrease, causing the other components to precipitate out. In contrast, using an excess of about 5% by weight of deionized water will lower both the freezing point and the boiling point of the resulting antifreeze composition, thus leading to undesired boiling over of the composition.

Optionally, in other embodiments of the invention, nitrate can be included as an additional component of the antifreeze composition. It can function to prevent corrosion of aluminum heating surfaces in the cooling system and pitting corrosion of aluminum. In preferred embodiments, it is used in the range of about 0.1-1 parts by weight based on 100 parts by weight of the liquid glycol-based antifreeze agent. Too small a proportion of nitrate, i.e. less than about 0.1 parts by weight, will not effectively prevent aluminum corrosion. In contrast, using an excess of 1 part by weight will have the undesired effect of corroding solder materials. In some embodiments of the invention, the nitrate to be used in the present invention is a member selected from sodium nitrate, potassium nitrate and mixtures thereof.

In still other embodiments of the invention, the antifreeze composition may further comprise additional components such as an anti-foaming agent or dyes. Anti-foaming agents and dyes useful for the present invention are well-known in the art.

The antifreeze composition of the present invention is prepared by mixing the aforementioned components with glycol and water in predetermined ratios as exemplified in Table 1, heated to about 40° C.-60° C. to form a homogeneous liquid with minimal precipitate to finally obtain the antifreeze composition of the present invention.

The following examples are provided by way of illustration only and not by way of limitation. Those of skill in the art will readily recognize a variety of non-critical parameters that could be changed or modified to yield essentially similar results.

### EXAMPLES

### Examples 1-4

As shown in the Table 1 below, all the components of the antifreeze composition were mixed with glycol and water in predetermined ratios as exemplified in Table 1, heated to about 50° C. to form a homogeneous liquid. The antifreeze compositions thereby produced were tested according to the test methods shown below and the results are shown in Tables 2-5.

### Comparative Example 1

### Organic Acid-based Longlife Hovoline Antifreeze Solution Manufactured by Texaco Co., Ltd. (U.S.A.)

### Comparative Example 2

### Phosphate Salt-based CROWN A-105 Antifreeze Solution Manufactured by KUKDONG JEYEN Co., Ltd. (Korea)

TABLE 1

| Category (g) | | Ex. 1 | Ex. 2 | Ex. 3 | Ex. 4 | Comp. Ex. 1 | Comp. Ex. 2 |
|---|---|---|---|---|---|---|---|
| liquid glycol-based | | 1) | 1) | 1) | 1) | Organic acid- | Crown A-105 |
| antifreeze agent | | | | | | based longlife | (KUKDONG |
| organic | methyl benzoate | — | 2.0 | — | 2.5 | Hovoline | JEYEN Co., |
| acid | sebacic acid | 1.5 | — | 2.1 | — | Antifreeze | Ltd., Korea) |

| dimercapto thiadiazole | | 0.1 | 0.05 | 0.15 | 0.3 | solution |
|---|---|---|---|---|---|---|
| Formula 1 compound | | 2.2 | 1.2 | 1.8 | 0.7 | manufactured |
| polymer stabilizer | | 0.01 | 0.1 | 0.4 | 0.08 | by Texaco |
| orthophosphoric acid | | 0.3 | 0.25 | 0.3 | 0.26 | Co., Ltd. |
| Additives | Tolytriazole | 0.3 | — | 0.3 | — | (U.S.A.) |
| | benzotriazole | — | 0.15 | — | 0.15 | |
| | mercapto | 0.12 | 0.18 | 0.15 | 0.2 | |
| | benzothiadiazole | | | | | |

| | | | | |
|---|---|---|---|---|
| sodium hydroxide | 2) | 2) | 2) | 2) |
| deionized water | 2.5 | 2.5 | 2.5 | 2.5 |
| anti-foaming agent | 0.002 | 0.002 | 0.002 | 0.002 |
| (Dow Corning FS 80) | | | | |

1) The amount to be added to make the final amount to 100%.
2) The amount to be added to make the final pH to 8.2.

TABLE 2

| | | | Ex. | | | | Comp. Ex. | |
|---|---|---|---|---|---|---|---|---|
| Category | | | 1 | 2 | 3 | 4 | 1 | 2 |
| Hard | wt. | aluminum | −0.02 | −0.01 | +0.04 | −0.03 | −0.05 | −0.06 |
| water | change | casting | | | | | (corrosion) | |
| 25 vol. % | ratio | cast iron | −0.03 | −0.02 | −0.03 | −0.04 | −0.02 | −0.02 |
| 98° C., | (mg/cm²) | steel | −0.02 | +0.01 | −0.02 | −0.01 | +0.02 | +0.02 |
| 336 hr | | brass | +0.03 | −0.04 | +0.05 | −0.04 | −0.04 | −0.06 |
| | | solder | −0.12 | +0.08 | −0.18 | +0.13 | −0.56 | −0.21 |
| | | | | | | | (corrosion) | |
| | | copper | −0.05 | −0.06 | −0.04 | −0.05 | −0.06 | −0.05 |
| Solution A | wt. | aluminum | −0.06 | −0.05 | −0.07 | −0.04 | −0.21 | −0.08 |
| 20 vol. % | change | casting | | | | | | |
| 98° C., | ratio | cast iron | −0.04 | −0.03 | +0.06 | −0.05 | +0.06 | −0.05 |
| 672 hr | (mg/cm²) | steel | −0.02 | +0.04 | −0.02 | −0.03 | −0.06 | −0.06 |
| | | brass | −0.06 | −0.08 | −0.07 | +0.04 | −0.05 | −0.12 |
| | | solder | −0.05 | +0.07 | −0.09 | −0.08 | −0.12 | −0.18 |
| | | copper | +0.07 | −0.06 | −0.08 | +0.05 | −0.05 | −0.10 |
| Solution B | wt. | aluminum | −0.07 | +0.06 | −0.05 | −0.06 | −0.58 | −0.12 |
| 20 vol. % | change | casting | | | | | (corrosion) | |
| 98° C., | ratio | cast iron | −0.03 | −0.02 | −0.01 | +0.02 | +0.01 | −0.08 |
| 672 hr | (mg/cm²) | steel | −0.01 | −0.03 | −0.02 | −0.04 | −0.07 | −0.06 |
| | | brass | +0.07 | −0.04 | +0.08 | +0.07 | −0.04 | −0.17 |
| | | solder | −0.07 | −0.06 | −0.09 | −0.06 | −0.05 | −0.15 |
| | | copper | −0.05 | +0.07 | −0.08 | −0.06 | −0.05 | −0.12 |
| Solution A | wt. | aluminum | −0.09 | −0.08 | −0.06 | −0.08 | +0.36 | −0.11 |
| 50 vol. % | change | casting | | | | | | |
| 98° C., | ratio | cast iron | −0.07 | −0.07 | −0.09 | +0.07 | +0.14 | −0.08 |
| 2000 hr | (mg/cm²) | steel | +0.04 | −0.04 | −0.07 | −0.08 | +0.09 | −0.10 |
| | | brass | +0.08 | +0.07 | −0.10 | −0.08 | −0.24 | −0.12 |
| | | solder | −0.12 | −0.09 | −0.14 | −0.12 | −1.38 | −0.23 |
| | | copper | −0.13 | −0.10 | +0.08 | +0.09 | +0.26 | −0.10 |

Corrosion was observed with the naked eye according to the metal corrosion test in KS M212142 8.3.

As used in the examples, “hard water” refers to a solution where 396 mg of CaCl₂ is dissolved in 1 L of distilled water.

As used in the examples, “Solution A” refers to a solution where 148 mg of Na₂SO₄, 165 mg of NaCl, and 138 mg of NaHCO₃ are dissolved in 1 L of distilled water.

As used in the examples, “Solution B” refers to a solution where 318 mg of NaCl, 296 mg of Na₂SO₄, 62 mg of NaNO₃, 1.5 mg of FeCl₃.6H₂O, 2.7 mg of CuCl₂.2H₂O, and 10.4 mg of ZnCl₂ are dissolved in 1 L of distilled water.

TABLE 3

| | | Ex. | | | | Comp. Ex. | |
|---|---|---|---|---|---|---|---|
| Category | | 1 | 2 | 3 | 4 | 1 | 2 |
| Aluminum | Change of liquid after | No | No | No | No | No | No |
| Heating | test | change | change | change | change | change | change |
| Surfaces | Ratio of weight | +0.26 | +0.29 | +0.24 | +0.27 | −1.52 | −2.12 |
| 20 vol. %, | change of a | | | | | | |
| 35 days | specimen (mg/cm²) | | | | | | |

TABLE 4

| | | | Ex. | | | | Comp. Ex. | |
|---|---|---|---|---|---|---|---|---|
| Category | | | 1 | 2 | 3 | 4 | 1 | 2 |
| Solution A | wt. | aluminum casting | −0.07 | −0.09 | −0.10 | −0.08 | +0.26 | −0.16 |
| 50 vol. % | change | | | | | | | (corrosion) |
| 98° C., | ratio | cast iron | −0.09 | −0.08 | −0.09 | −0.10 | −0.14 | −0.34 |
| 4000 hr | (mg/cm²) | | | | | | | (corrosion) |
| | | steel | −0.10 | −0.12 | −0.11 | −0.09 | +0.21 | −0.14 |
| | | brass | −0.12 | −0.07 | −0.09 | −0.13 | −0.11 | −0.29 |
| | | solder | −0.09 | −0.11 | −0.08 | −0.13 | −3.16 | −2.14 |
| | | | | | | | (corrosion) | (corrosion) |
| | | copper | −0.10 | −0.11 | −0.12 | −0.09 | +0.26 | −0.32 |

TABLE 5

| | | | Ex. | | | | Comp. Ex. | |
|---|---|---|---|---|---|---|---|---|
| Category | | | 1 | 2 | 3 | 4 | 1 | 2 |
| Solution A | wt. | aluminum casting | −0.09 | −0.08 | −0.07 | +0.09 | −0.09 | −1.12 |
| 30 vol. % | change | | | | | | | (corrosion) |
| 98° C., | ratio | cast iron | −0.10 | −0.12 | −0.09 | −0.08 | +0.07 | −0.39 |
| 336 hr | (mg/cm²) | | | | | | | (corrosion) |
| | | steel | −0.08 | +0.07 | −0.09 | −0.06 | −0.08 | −0.17 |
| | | brass | +0.09 | −0.08 | +0.10 | +0.12 | −0.17 | −0.24 |
| | | solder | −0.13 | −0.10 | −0.11 | −0.09 | −0.24 | −0.28 |
| | | copper | −0.08 | +0.07 | −0.10 | −0.11 | +0.19 | −0.22 |

<Test Method>

Lifespan of antifreeze fluid prepared in Example 1 and Comparative Examples (Hovoline antifreeze fluid, TexacoCo., Ltd. & CROWN A-105, Kukdong Jeyen Co., Ltd.) was tested on various metals at standard concentration (50%) and low concentration (20%) by means of metal corrosion test, ASTM heating surface test, circulation corrosion test, and thermal oxidation test at high temperatures.

Metal corrosion test was performed using antifreeze solutions at 20 vol. %, 25 vol. %, and 50 vol. %, respectively, obtained by dilution with Solution A and B using the metal corrosion test (KS M2142 8.3) at 98° C. for 336 hr, 672 hr, and 2000 hr. respectively.

Aluminum casting heating surface test was performed by using 20 vol. % of an antifreeze solution obtained by dilution based on the ASTM combinatory number at 135° C. under the pressure of 193 kPa for 35 days to compare the amount of floating matter in the antifreeze solution and anticorrosion property of the antifreeze composition on aluminum casting surfaces.

Circulation corrosion test is designed to evaluate the anticorrosion property by circulating an antifreeze solution in conditions simulating that of a real automobile by installing parts such as radiator, heater core, water pump, rubber hose, reserve tank, and the like. In the present invention, this test was performed using antifreeze solutions of 50 vol. %, the same concentration as that used in a real automobile, obtained by dilution based on the ASTM combinatory number at 98° C. for 4000 hr.

Thermal oxidation test at high temperature is designed to evaluate the durability of the composition over extended use by forcefully heat-oxidizing an antifreeze solution to simulate conditions in a real automobile and testing its anticorrosion properties. In the present invention, this test was performed by adding 250 mL of undiluted antifreeze solution into a tall beaker, wherein a 800 cm² copper plate has been placed, and forcefully agitating the solution at a rate of 1300 rpm and followed by testing at 130° C. for 400 hr. Then, the specimen was collected and placed under the thermal oxidation test at high temperatures and the level of thermal oxidation evaluated.

Test results shown in the above tables are as follows: table 2 shows the results of metal corrosion test, table 3 shows the results of ASTM heating surface test, table 4 shows the result of circulation corrosion test, and table 5 shows thermal oxidation test under high temperature conditions.

In conclusion, the antifreeze solution of the present invention has superior chemical stability, stable weight change ratio, and sustained anticorrosion property, even at different levels of dilution and for different combinatory numbers.

As stated above, the antifreeze fluid composition of the present invention is chemically stable, has superior anticorrosion properties even at low concentrations and in the presence of hard water, as well as excellent durability under high temperature conditions. Further, the makeup of the composition can significantly reduce the rate at which the antifreeze is depleted, thereby making it more environmentally-friendly and longer-lasting.

Those of ordinary skill in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth herein.

1. An antifreeze composition comprising
(a) about 85-98% by weight of a liquid glycol-based antifreeze agent;
(b) about 0.1-6% by weight of an alkali metal salt or an ammonium salt of C₄-C₁₆ carboxylic acid;
(c) about 0.001-0.5% by weight of dimercapto thiadiazole;
(d) about 0.1-5% by weight of a poly(organic acid) having formula 1;
(e) about 0.01-5% by weight of a hard water stabilizer having formula 2;
(f) about 0.1-0.5% by weight of a phosphoric acid or salt thereof;
(g) about 0.01-2% by weight of triazole or thiazole;
(h) about 0.1-4% by weight of alkali metal hydroxide; and
(i) about 1-3% by weight of deionized water, 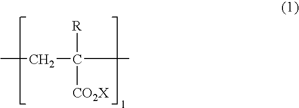
wherein l is an integer from 10-100; R is a member selected from —H, —CH₃, —CO₂H, and —SO₃H; X is a member selected from —H, —CH₂CH₂OH, —CH₂CH₂CO₂H; and —CH₂OCH₂CH(OH)CH₂SO₃H, and 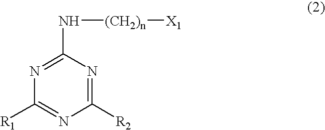
wherein X₁ is a member selected from —OH, —COOH, —CH₃, and —CH═CH(CH₂)n-CH₃; R₁ and R₂ are members independently selected from a straight or branched C₁-C₁₂ alkyl group, —(CH₂)m-X₂, and —NH—(CH₂)m-X₂; n is an integer from 1-16; m is an integer from 1-16; X₂ is a member selected from —OH, —COOH, —CH₃, and —CH═CH(CH₂)n-CH₃.

2. The composition of claim 1, wherein said antifreeze agent is a member selected from the group consisting of ethylene glycol, dimethylene glycol, propylene glycol, dipropylene glycol, and mixtures thereof.

3. The composition of claim 1, wherein said alkali metal salt or said ammonium salt of C₄-C₁₆ carboxylic acid is a member selected from the group consisting of succinic acid, glutaric acid, adipic acid, pimelic acid, suberic acid, azelaic acid, sebacic acid, dicyclopentadiene dicarboxylic acid, phthalic acid, terephthalic acid, pentanoic acid, hexanoic acid, heptanoic acid, octanoic acid, 2-ethylhexanoic acid, nonanoic acid, decanoic acid, undecanoic acid, dodecanoic acid, benzoic acid, methylbenzoic acid, an butylbenzoic acid, and mixtures thereof.

4. The composition of claim 1, wherein said phosphoric acid or salt thereof is a member selected from the group consisting of orthophosphoric acid and alkali metal phosphate salt.

5. The composition of claim 1, wherein said triazole is a member selected from the group consisting of tolytriazole, benzotriazole, or mixtures thereof.

6. The composition of claim 1, wherein said thiazole is mercapto benzothiadiazole.

7. The composition of claim 1, wherein said alkali metal hydroxide is a member selected from the group consisting of lithium hydroxide, sodium hydroxide, potassium hydroxide, and mixtures thereof.

8. The composition of claim 1, further comprising about 0.1-1 parts by weight of nitrate based on 100 parts by weight of the glycol-based antifreeze agent.
